(19) United States
(12) Patent Application Publication
(10) Pub. No.: US 2022/0197180 A1
(43) Pub. Date: Jun. 23, 2022

(54) IMAGE FORMING APPARATUS

(71) Applicant: TOSHIBA TEC KABUSHIKI KAISHA, Tokyo (JP)

(72) Inventor: Takahiro Kojima, Mishima Shizuoka (JP)

(21) Appl. No.: 17/336,381

(22) Filed: Jun. 2, 2021

(30) Foreign Application Priority Data
Dec. 18, 2020 (JP) 2020-210258

(51) Int. Cl. G03G 15/04; G02B 26/12

(52) U.S. Cl. CPC G03G 15/04036; G02B 26/124

(57) ABSTRACT

An image forming apparatus includes an exposure device configured to form a latent image on a photoreceptor. The exposure device includes a polygon mirror motor, a polygon mirror pre-incidence optical system, a post-scan optical system, and a housing. The polygon mirror pre-incidence optical system includes a light source station configured to emit the light beam. The post-scan optical system is configured to irradiate the photoreceptor with the light beam. The housing includes a first holding portion, a second holding portion, and a slit. The slit is formed between the first holding portion and the second holding portion. The slit is configured to separate the first holding portion and the second holding portion in a region corresponding to a gap between the light source station and the polygon mirror motor.

### CROSS-REFERENCE TO RELATED APPLICATION

This application is based upon and claims the benefit of priority from Japanese Patent Application No. 2020-210258, filed on Dec. 18, 2020 the entire contents of which are incorporated herein by reference.

### FIELD

Embodiments described herein relate generally to an image forming apparatus.

### BACKGROUND

An electrophotographic image forming apparatus exposes a photoreceptor to a light beam to form a latent image, develops the latent image to form a transfer original image, and transfers the transfer original image to an image forming medium. For example, the image forming apparatus includes: a polygon mirror motor that deflects a light beam for scanning; a pre-incidence optical system that causes a light beam emitted from a light source to be incident on the polygon mirror motor; and a post-scan optical system that irradiates the photoreceptor with the light beam after scanning. In order to reduce costs, a type in which the components including the polygon mirror motor, the pre-incidence optical system, and the post-scan optical system are fixed to one resin housing is widely used.

The polygon mirror motor increases a temperature of a surrounding atmosphere during driving. This temperature increase deforms the resin housing. The deformation of the housing displaces the components including the pre-incidence optical system and the post-scan optical system, which causes a variation in exposure position on the photoreceptor. The variation in exposure position causes deterioration in quality of a formed image. Therefore, it is desired to suppress the variation in exposure position.

### DESCRIPTION OF THE DRAWINGS

FIG. 1 is a diagram schematically illustrating a configuration of an image forming apparatus according to an embodiment;

FIG. 2 is a schematic diagram illustrating a schematic configuration of an image forming unit;

FIG. 3 is a perspective view illustrating an external appearance shape when an exposure device illustrated in FIG. 1 is seen from the top;

FIG. 4 is a perspective view illustrating a state where an upper cover and a lower cover are removed from the exposure device illustrated in FIG. 3;

FIG. 5 is a perspective view illustrating a state where a second folding mirror, a third folding mirror, a fourth folding mirror, and a polygon mirror motor upper seal are removed from the exposure device illustrated in FIG. 4;

FIG. 6 is a perspective view illustrating an external appearance shape when the exposure device illustrated in FIG. 3 is seen from the bottom;

FIG. 7 is a perspective view illustrating a state where an upper cover and a lower cover are removed from the exposure device illustrated in FIG. 6;

FIG. 8 is a perspective view illustrating a state where a polygon plate is removed from the exposure device illustrated in FIG. 7;

FIG. 9 is a cross-sectional view taken along line A-A of the exposure device illustrated in FIG. 4;

FIG. 10 is a cross-sectional view taken along line B-B of the exposure device illustrated in FIG. 3 and illustrating optical paths of a first post-scan optical system and a fourth post-scan optical system;

FIG. 11 is a cross-sectional view taken along line B-B of the exposure device illustrated in FIG. 3 and illustrating optical paths of a second post-scan optical system and a third post-scan optical system;

FIG. 12 is a perspective view of the exposure device corresponding to FIG. 4 and illustrating a state where a housing is deformed by heat generated by the driving of the polygon mirror motor;

FIG. 13 is a cross-sectional view taken along line C-C of the exposure device illustrated in FIG. 12;

FIG. 14 is a cross-sectional view illustrating an exposure device according to Comparative Example where the slit is not formed in the housing; and

FIG. 15 is a graph illustrating displacements of optical elements in light source stations in the exposure devices according to the embodiment and Comparative Example.

### DETAILED DESCRIPTION

Embodiments provide an image forming apparatus in which a variation in exposure position on a photoreceptor that causes a temperature increase in a surrounding atmosphere of a polygon mirror motor that is being driven is small.

According to one embodiment, an image forming apparatus includes an exposure device configured to expose a photoreceptor to a light beam to form a latent image. The exposure device includes a polygon mirror motor, a polygon mirror pre-incidence optical system, a post-scan optical system, and a housing. The polygon mirror motor includes a rotatable polygon mirror configured to deflect the light beam for scanning. The polygon mirror pre-incidence optical system is configured to cause the light beam to be incident on the polygon mirror, the polygon mirror pre-incidence optical system including a light source station configured to emit the light beam. The post-scan optical system is configured to irradiate the photoreceptor with the light beam deflected by the polygon mirror for scanning. The housing is formed of a resin, holds the polygon mirror motor, the polygon mirror pre-incidence optical system, and the post-scan optical system. The housing includes a first holding portion, a second holding portion, and a slit. The first holding portion is configured to hold the light source station. The second holding portion is configured to hold the polygon mirror motor. The slit is formed between the first holding portion and the second holding portion. The slit is configured to separate the first holding portion and the second holding portion in a region corresponding to a gap between the light source station and the polygon mirror motor.

Hereinafter, an image forming apparatus according to an embodiment will be described with reference to the drawings. In addition, in each of the drawings used for the description of the embodiment, the scale of each of components may be appropriately changed. In addition, each of the drawings in the embodiment may not illustrate a configuration for description.

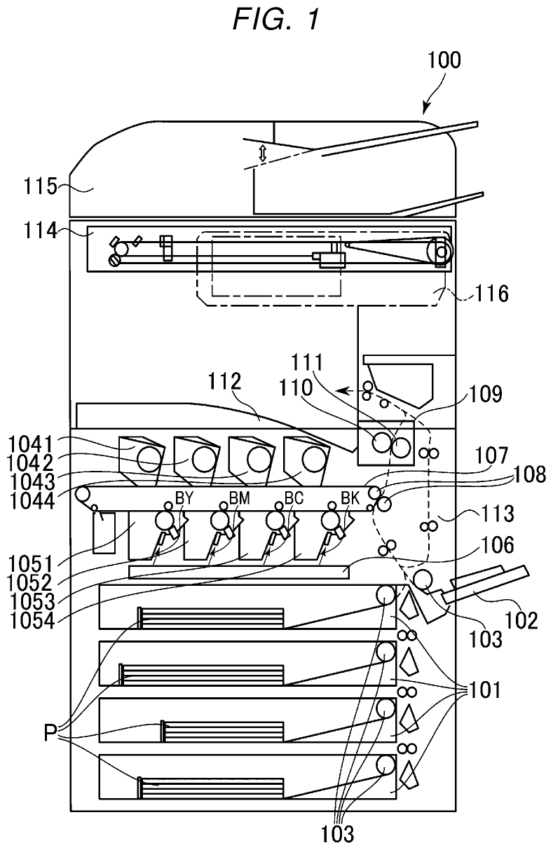

FIG. 1 is a diagram schematically illustrating a configuration of an image forming apparatus 100 according to the embodiment. The image forming apparatus 100 forms an image on an image forming medium using an electrophotographic method. The image forming apparatus 100 is, for example, a multifunction peripheral (MFP), a copying machine, a printer, or a facsimile machine. In the following description, it is assumed that the image forming apparatus 100 is an MFP.

The image forming apparatus 100 has, for example, a printing function, a scanning function, and a copying function. The printing function is a function of forming an image on an image forming medium P or the like using a recording agent such as toner. The image forming medium P is, for example, sheet-like paper. The scanning function is a function of reading an image from a document or the like on which an image is formed. The copying function is a function of printing an image that is read from a document or the like using the scanning function on the image forming medium P using the printing function.

The image forming apparatus 100 includes a paper feed tray 101, a manual feed tray 102, and a paper feed roller 103.

The paper feed tray 101 accommodates an image forming medium P using printing. The manual feed tray 102 is a tray for manually feeding the image forming medium P.

The paper feed roller 103 rotates along with movement of a motor such that the image forming medium P accommodated in the paper feed tray 101 or the manual feed tray 102 is discharged from the paper feed tray 101.

The paper feed tray 101, the manual feed tray 102, and the paper feed roller 103 configure an image forming medium supply device that supplies an image forming medium.

The image forming apparatus 100 includes a plurality of toner cartridges 1041, 1042, 1043, and 1044, a plurality of image forming units 1051, 1052, 1053, and 1054, an exposure device 106, a transfer belt 107, and a secondary transfer roller 108.

For example, the image forming apparatus 100 includes four toner cartridges 1041 to 1044 and four image forming units 1051 to 1054. The toner cartridge 1041 to 1044 contain toners that are supplied to the image forming units 1051 to 1054. The four toner cartridges 1041 to 1044 contain toners corresponding to the respective colors of CMYK in order to form a color image. The toner cartridge 1041 contains yellow toner. The toner cartridge 1042 contains magenta toner. The toner cartridge 1043 contains cyan toner. The toner cartridge 1044 contains a key plate color such as black color.

The colors of the toners in the toner cartridges 1041 to 1044 are not limited to the respective colors of CMYK and may be other colors. In addition, the toner in the toner cartridges 1041 to 1044 may be a special toner. For example, the toner cartridges 1041 to 1044 may contain a decolorable toner that enters a state where the toner is erased and invisible at a temperature higher than a predetermined temperature.

The image forming units 1051 to 1054 receive the toners supplied from the toner cartridges 1041 to 1044 and form colors of different colors. The image forming unit 1051 forms a yellow (Y) image. The image forming unit 1052 forms a magenta (M) image. The image forming unit 1053 forms a cyan (C) image. The image forming unit 1054 forms a black (K) image.

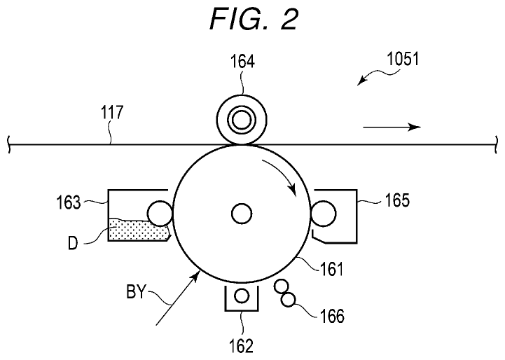

The image forming units 1051 to 1054 have the same configuration except for the difference in toner. Here, the representative image forming unit 1051 will be described with reference to FIG. 2. FIG. 2 is a schematic diagram illustrating a schematic configuration of the image forming unit 1051.

The image forming unit 1051 includes a photoconductive drum 161, a charging unit 162, a developing device 163, a primary transfer roller 164, a cleaner 165, and a charge erasing lamp 166.

The photoconductive drum 161 is irradiated with a light beam YB emitted from the exposure device 106. As a result, an electrostatic latent image is formed on a surface of the photoconductive drum 161.

The charging unit 162 charges the surface of the photoconductive drum 161 with predetermined positive charge.

The developing device 163 develops an electrostatic latent image on the surface of the photoconductive drum 161 using toner D supplied from the toner cartridge 1041. As a result, the developing device 163 forms a transfer original image on the surface of the photoconductive drum 161, the transfer original image being a toner D image to be transferred to the image forming medium P.

The primary transfer roller 164 is arranged at a position facing the photoconductive drum 161 with the transfer belt 107 interposed therebetween. The primary transfer roller 164 generates a transfer voltage between the primary transfer roller 164 and the photoconductive drum 161. As a result, the primary transfer roller 164 transfers (primarily transfers) the transfer original image formed on the surface of the photoconductive drum 161 to the transfer belt 107 in contact with the photoconductive drum 161.

The cleaner 165 removes the toner D remaining on the surface of the photoconductive drum 161.

The charge erasing lamp 166 removes charge remaining on the surface of the photoconductive drum 161.

In FIG. 1, the exposure device 106 will also be referred to as, for example, “laser scanning unit (LSU)”. The exposure device 106 irradiates the image forming units 1051, 1052, 1053, and 1054 with light beams BY, BM, BC, and BK, respectively, according to image data to be input. The light beams BY, BM, BC, and BK form the images of the colors Y, M, C, and K, respectively.

The exposure device 106 controls the light beam BY according to a Y component of the image data such that an electrostatic latent image is formed on the surface of the photoconductive drum 161 of the image forming unit 1051. Likewise, the exposure device 106 controls the light beams BM, BC and BK according to M, C, and K components of the image data such that electrostatic latent images are formed on the surfaces of the photoconductive drums 161 of the image forming units 1052, 1053, and 1054.

The image data to be input is, for example, image data to be read from a document by a scanner unit 114. Alternatively, the image data to be input is image data that is transmitted from another device or the like and is received by the image forming apparatus 100.

The transfer belt 107 is, for example, an endless belt and is rotatable by movement of a roller. By rotating, the transfer belt 107 conveys the transfer original image (primary transfer image) transferred from the image forming units 1051 to 1054 to a position of the secondary transfer roller 108.

The secondary transfer roller 108 includes two rollers facing each other. The secondary transfer roller 108 transfers (secondarily transfers) the images formed on the transfer belt 107 to the image forming medium P that passes through the rollers of the secondary transfer roller 108.

The photoconductive drum 161, the primary transfer roller 164, the transfer belt 107, and the secondary transfer roller 108 configure a transfer device that transfers the transfer original image to the image forming medium.

The image forming apparatus 100 further includes a fixing unit 109. The fixing unit 109 applies heat and pressure to the image forming medium P to which the image is transferred. As a result, the image transferred to the image forming medium P is fixed. The fixing unit 109 includes a heating unit 110 and a pressurization roller 111 that face each other.

The heating unit 110 is, for example, a roller including a heat source for heating the heating unit 110. The heat source is, for example, a heater. The roller heated by the heat source heats the image forming medium P. The pressurization roller 111 pressurizes the image forming medium P that passes through a gap between the pressurization roller 111 and the heating unit 110.

The image forming apparatus 100 further includes a paper discharge tray 112, a duplex unit 113, the scanner unit 114, a document feeder 115, and a control panel 116.

The paper discharge tray 112 discharges the printed image forming medium P.

The duplex unit 113 makes the image forming medium P to enter a state where a back surface thereof is printable. For example, the duplex unit 113 inverts the image forming medium P upside down by switching back the image forming medium P using a roller or the like.

The scanner unit 114 reads an image from a document and supplies the image data to the exposure device 106. The scanner unit 114 corresponds to a scanner that reads an image from a document. The scanner is, for example, an optical reduction type including an imaging element such as a charge-coupled device (CCD) image sensor. Alternatively, the scanner may be a contact image sensor (CIS) type including an imaging element such as a complementary metal-oxide-semiconductor (CMOS) image sensor. Alternatively, the scanner may be another well-known type.

The document feeder 115 is also called, for example, an auto document feeder (ADF). The document feeder 115 conveys documents placed on a document tray one by one. An image of the conveyed document is read by the scanner unit 114. In addition, the document feeder 115 may include a scanner for reading an image from a back surface of the document.

The control panel 116 includes, for example, a button and a touch panel that are operated by an operator of the image forming apparatus 100. In the touch panel, for example, a display such as a liquid crystal display or an organic EL display and a pointing device using a touch input are laminated. Accordingly, the button and the touch panel function as an input device that receives an operation of the operator of the image forming apparatus 100. In addition, the display in the touch panel functions as a display device that notifies various information to the operator of the image forming apparatus 100.

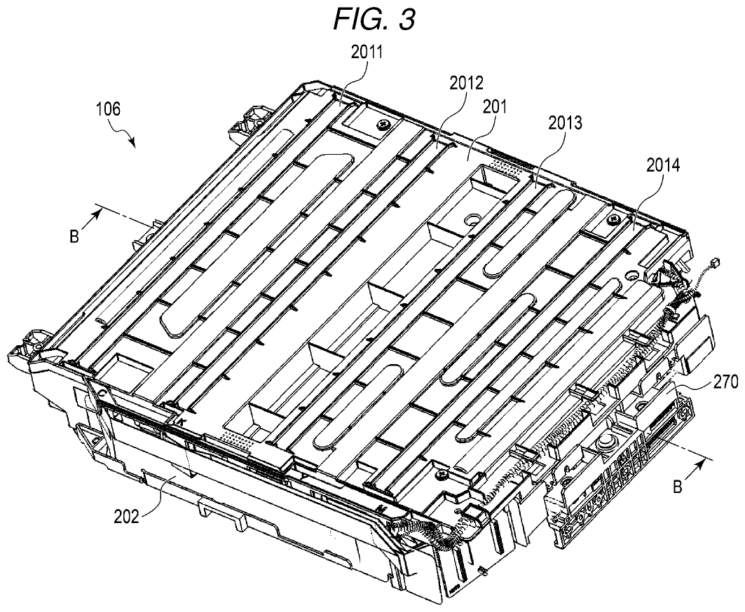

Next, a configuration of the exposure device 106 will be described with reference to FIGS. 3 to 11. Hereinafter, when incorporated into the image forming apparatus 100, a side of the exposure device 106 facing the image forming units 1051 to 1054 will be referred to as “upper side”, and a side of the exposure device 106 facing the paper feed tray 101 will be referred to as “lower side”. In addition, “upper portion”, “above”, “lower portion”, “below”, and the like are based on the upper side and the lower side.

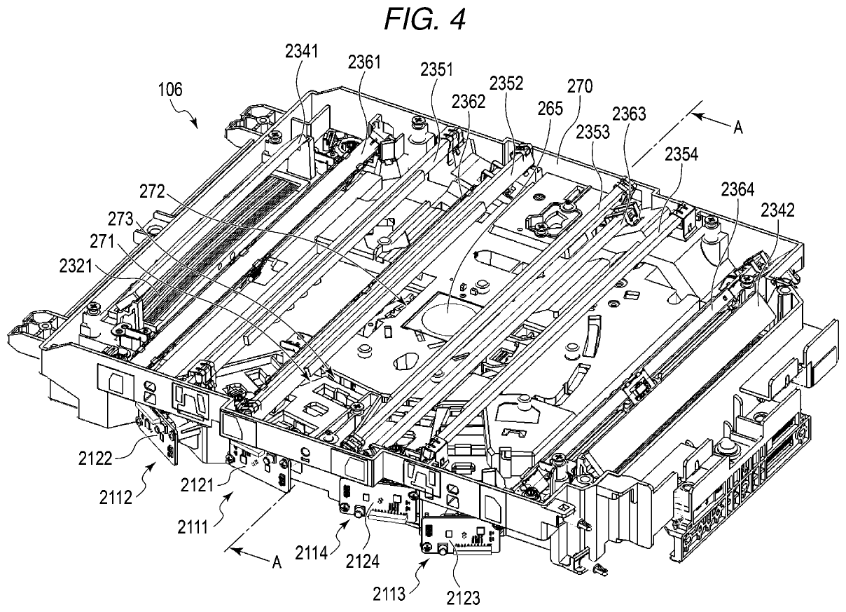

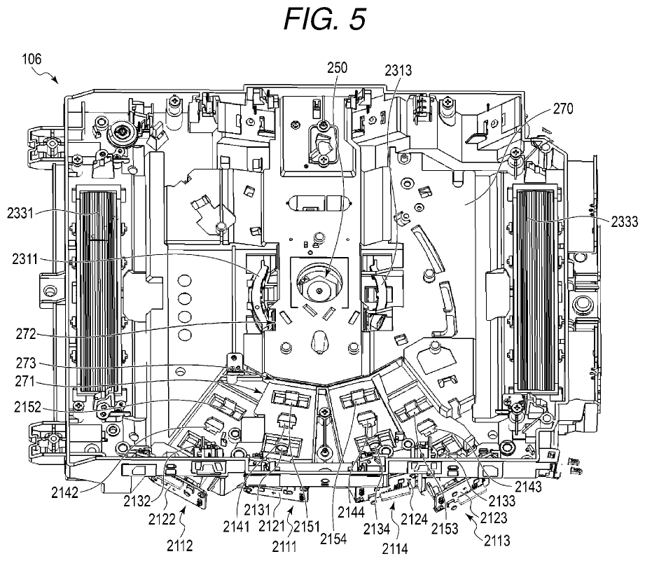

FIG. 3 is a perspective view illustrating an external appearance shape when the exposure device 106 illustrated in FIG. 1 is seen from the top. FIG. 4 is a perspective view illustrating a state where an upper cover 201 and a lower cover 202 are removed from the exposure device 106 illustrated in FIG. 3. FIG. 5 is a perspective view illustrating a state where second folding mirrors 2341 and 2343, third folding mirrors 2351, 2352, 2353, and 2354, fourth folding mirrors 2361, 2362, 2363, and 2364, and a polygon mirror motor upper seal 265 are removed from the exposure device 106 illustrated in FIG. 4. In FIGS. 3 to 5, the upper side of the exposure device 106 is arranged on the upper side of the paper plane.

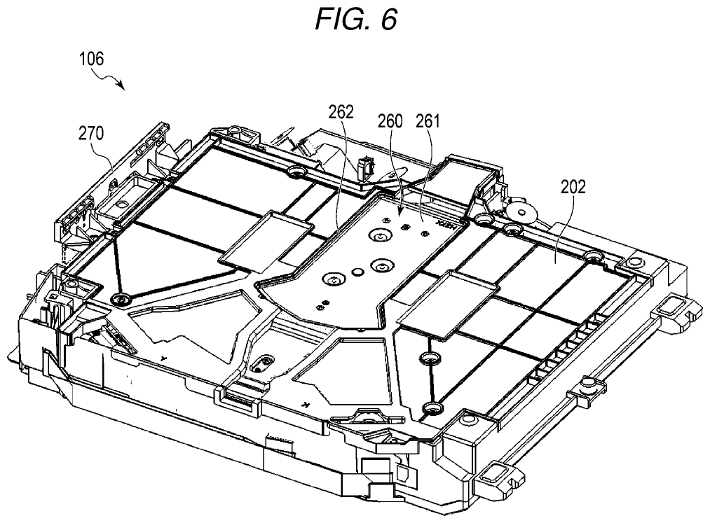

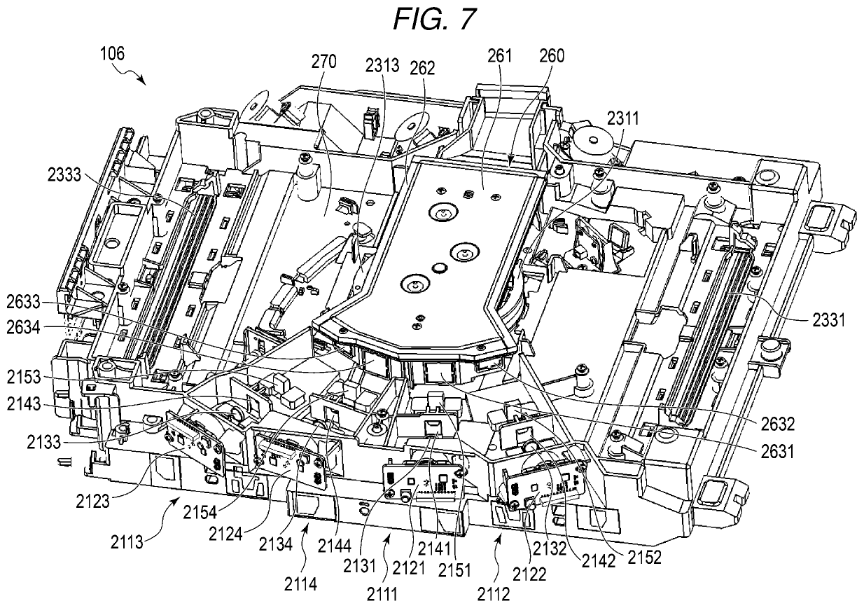

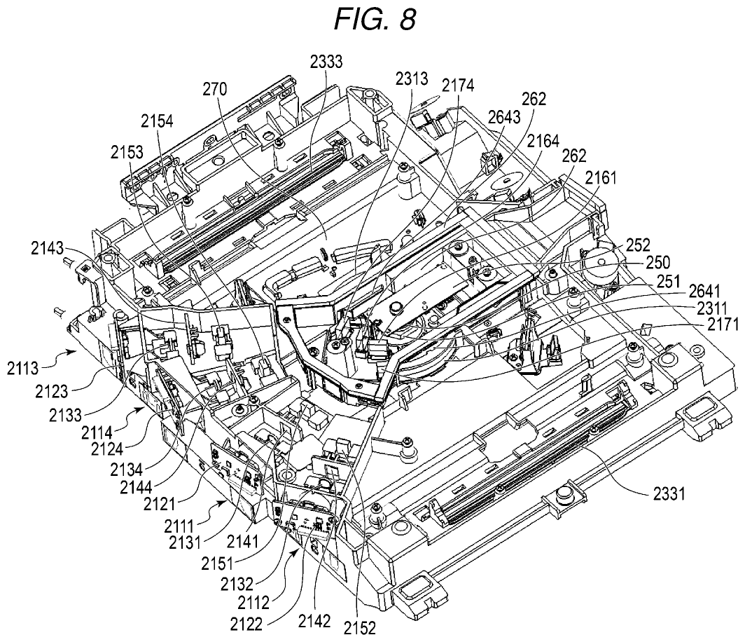

FIG. 6 is a perspective view illustrating an external appearance shape when the exposure device 106 is seen from the bottom. FIG. 7 is a perspective view illustrating a state where the upper cover 201 and the lower cover 202 are removed from the exposure device 106 illustrated in FIG. 6. FIG. 8 is a perspective view illustrating a state where a polygon plate 261 that is a fixing component of a polygon mirror motor 250 is removed from the exposure device 106 illustrated in FIG. 7. In FIGS. 6 to 9, the lower side of the exposure device 106 is arranged on the upper side of the paper plane.

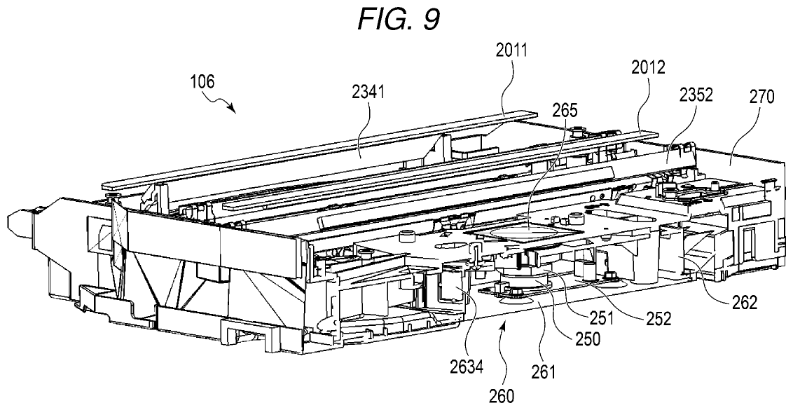

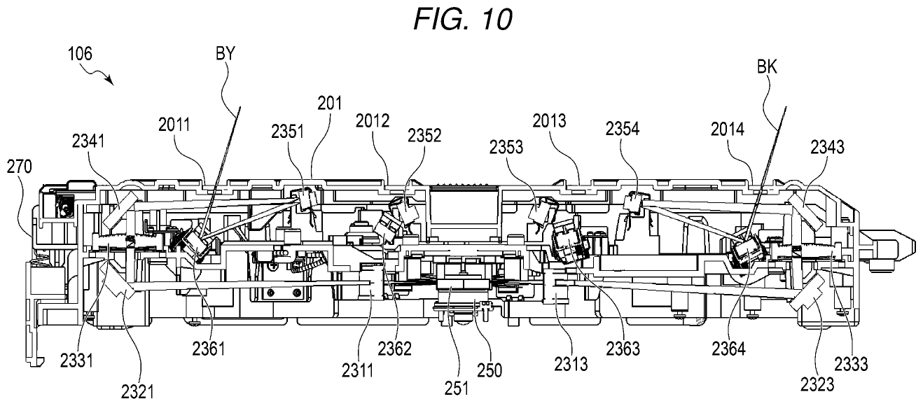

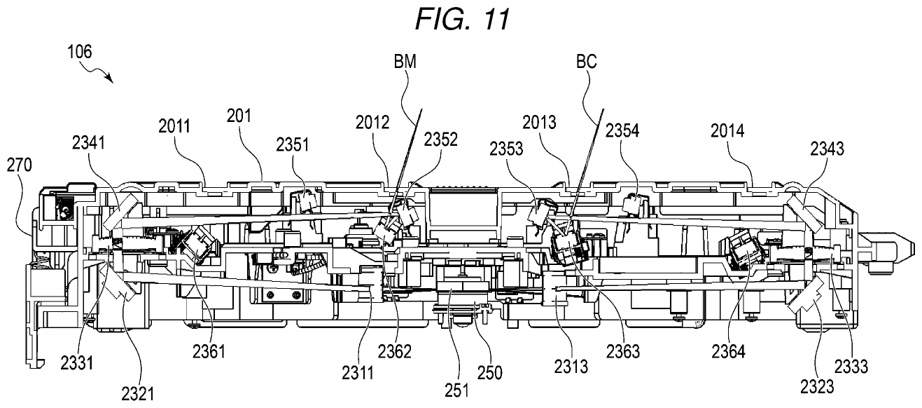

FIG. 9 is a cross-sectional view taken along line A-A of the exposure device 106 illustrated in FIG. 4. FIG. 10 is a cross-sectional view taken along line B-B of the exposure device 106 illustrated in FIG. 3 and illustrating optical paths of a first post-scan optical system and a fourth post-scan optical system. FIG. 11 is a cross-sectional view taken along line B-B of the exposure device 106 illustrated in FIG. 3 and illustrating optical paths of a second post-scan optical system and a third post-scan optical system.

As illustrated in FIGS. 3 and 6, the exposure device 106 includes a housing 270, the upper cover 201, and the lower cover 202 as a housing that houses components of the exposure device 106. The housing 270 holds the components of the exposure device 106. The components of the exposure device 106 are fixed to the housing 270 by adhesion or using a spring, a screw, or the like. The upper cover 201 is attached to an upper portion of the housing 270 and covers the upper sides of the components of the exposure device 106. The lower cover 202 is attached to a lower portion of the housing 270 and covers the lower sides of the components of the exposure device 106.

The housing 270 includes, for example, a plate portion that spreads across the vertical direction, a wall portion that spreads in the vertical direction, and a fixing portion to which the components of the exposure device 106 are fixed. The housing 270 is formed of a resin, in which the plate portion, the wall portion, the fixing portion, and the like are integrally formed.

In the upper cover 201, slit glasses 2011, 2012, 2013, and 2014 through which the light beams BY, BM, BC, and BK to be incident on the image forming units 1051, 1052, 1053, and 1054 pass are provided.

As illustrated in FIGS. 8 to 11, the exposure device 106 includes the single polygon mirror motor 250 that commonly deflects the light beams BY, BM, BC, and BK to be respectively incident on the four image forming units 1051, 1052, 1053, and 1054 for scanning.

The polygon mirror motor 250 includes a rotatable polygon mirror 251. The polygon mirror 251 includes a plurality of reflection surfaces on an outer circumference around a rotation axis. The polygon mirror 251 deflects the light beams BY, BM, BC, and BK by reflecting the light beams BY, BM, BC, and BK to be incident. In addition, by rotating, the polygon mirror 251 deflects the light beams BY, BM, BC, and BK for scanning.

As illustrated in FIGS. 7 to 9, the polygon mirror motor 250 includes a polygon mirror motor housing portion 260. the polygon mirror motor housing portion 260 holds the housing 270. The polygon mirror motor housing portion 260 includes the polygon plate 261 and a polygon hood 262.

The polygon mirror motor 250 includes a substrate 252 on which a driver IC and the like are mounted. The substrate 252 of the polygon mirror motor 250 is fixed to the polygon plate 261. The polygon plate 261 is fixed to the polygon hood 262 and blocks a lower portion of the polygon hood 262. The polygon plate 261 is formed of a metal. The polygon hood 262 surrounds the periphery of the polygon mirror motor 250 and is held by the housing 270. The housing 270 blocks an upper portion of the polygon hood 262.

As illustrated in FIG. 7, in the polygon hood 262, incidence side cover glasses 2631, 2632, 2633, and 2634 on which the light beams BY, BM, BC, and BK deflected by the polygon mirror 251 for scanning are incident are provided.

As illustrated in FIG. 8, in the polygon hood 262, an emission side cover glass 2641 from which the light beams BY and BM deflected by the polygon mirror 251 for scanning are emitted and an emission side cover glass 2643 from which the light beams BC and BK deflected by the polygon mirror 251 for scanning are emitted are further provided.

As illustrated in FIG. 5, the housing 270 has an opening in an upper portion of the polygon mirror motor 250. As illustrated in FIGS. 4 and 9, this opening is blocked by the polygon mirror motor upper seal 265.

The components of the polygon mirror motor housing portion 260, that is, the polygon plate 261, the polygon hood 262, the incidence side cover glasses 2631 to 2634, the emission side cover glasses 2641 and 2643, and the polygon mirror motor upper seal 265 configure a closed structure together with the housing 270.

As illustrated in FIGS. 4 and 5, FIGS. 7 and 8, and FIGS. 10 and 11, to correspond to the four image forming units 1051 to 1054, the exposure device 106 further includes: four polygon mirror pre-incidence optical systems that cause the light beams BY, BM, BC, and BK to be incident on the polygon mirror 251; and four post-scan optical systems that cause the light beams BY, BM, BC, and BK deflected by the polygon mirror 251 for scanning to be incident on the photoconductive drums 161 of the image forming units 1051 to 1054. The components of the polygon mirror pre-incidence optical systems and the components of the post-scan optical systems are held by the housing 270.

In this specification, the polygon mirror pre-incidence optical system and the post-scan optical system of the light beam BY will be referred to as “first polygon mirror pre-incidence optical system” and “first post-scan optical system”, respectively. The polygon mirror pre-incidence optical system and the post-scan optical system of the light beam BM will be referred to as “second polygon mirror pre-incidence optical system” and “second post-scan optical system”, respectively. The polygon mirror pre-incidence optical system and the post-scan optical system of the light beam BC will be referred to as “third polygon mirror pre-incidence optical system” and “third post-scan optical system”, respectively. The polygon mirror pre-incidence optical system and the post-scan optical system of the light beam BK will be referred to as “fourth polygon mirror pre-incidence optical system” and “fourth post-scan optical system”, respectively.

The first polygon mirror pre-incidence optical system includes a light source station 2111 that emits the light beam BY. The second polygon mirror pre-incidence optical system includes a light source station 2112 that emits the light beam BM. The third polygon mirror pre-incidence optical system includes a light source station 2113 that emits the light beam BC. The fourth polygon mirror pre-incidence optical system includes a light source station 2114 that emits the light beam BK. The light source stations 2111 to 2114 are held by the housing 270.

The light source stations 2111 to 2114 have the same structure and include laser diodes 2121, 2122, 2123, and 2124, collimator lenses 2131, 2132, 2133, and 2134, apertures 2141, 2142, 2143, and 2144, and cylindrical lenses 2151, 2152, 2153, and 2154, respectively.

The laser diodes 2121 to 2124 emit light beams. The collimator lenses 2131 to 2134 convert light beams into collimated light beams. The apertures 2141 to 2144 shape the light beams. The cylindrical lenses 2151 to 2154 convert light beams into flat light beams and focus the light beams on the reflection surfaces of the polygon mirror 251.

As illustrated in FIG. 8, the first polygon mirror pre-incidence optical system further includes two polygon mirror pre-incidence mirrors 2161 and 2171. In addition, the fourth polygon mirror pre-incidence optical system further includes two polygon mirror pre-incidence mirrors 2164 and 2174. The polygon mirror pre-incidence mirrors 2161, 2171, 2164, and 2174 are arranged in the polygon mirror motor housing portion 260.

The two polygon mirror pre-incidence mirrors 2161 and 2171 are provided to match an optical path length of the first polygon mirror pre-incidence optical system and an optical path length of the second polygon mirror pre-incidence optical system to each other. In addition, the two polygon mirror pre-incidence mirrors 2161 and 2171 are provided to align an incidence position of the light beam BY on the polygon mirror 251 with an incidence position of the light beam BM on the polygon mirror 251 in the vertical direction.

In addition, the two polygon mirror pre-incidence mirrors 2164 and 2174 are provided to match optical path lengths of the fourth polygon mirror pre-incidence optical system and the third polygon mirror pre-incidence optical system to each other and to align incidence positions of the light beam BK and the light beam BC on the polygon mirror 251 in the vertical direction.

In FIG. 8, the light beam BM emitted from the light source station 2112 passes through the incidence side cover glass 2632 and enters into the polygon mirror motor housing portion 260. Next, the light beam BM passes through a region (upper side in FIG. 8) below the polygon mirror pre-incidence mirror 2171 of the first polygon mirror pre-incidence optical system and is incident on the polygon mirror 251.

The light beam BY emitted from the light source station 2111 passes through the incidence side cover glass 2631 and enters into the polygon mirror motor housing portion 260. Next, the light beam BY is reflected by the two polygon mirror pre-incidence mirrors 2161 and 2171 in order. As a result, the optical path of the light beam BY is aligned with the optical path of the light beam BM in the vertical direction. Next, the light beam BY is incident on the polygon mirror 251.

Likewise, the light beam BC emitted from the light source station 2113 passes through the incidence side cover glass 2633, passes through a region (upper side in FIG. 8) below the polygon mirror pre-incidence mirror 2174, and is incident on the polygon mirror 251.

The light beam BK emitted from the light source station 2114 passes through the incidence side cover glass 2634, is reflected by the two polygon mirror pre-incidence mirrors 2164 and 2174 in order, and is incident on the polygon mirror 251.

The light beams BY, BM, BC, and BK incident on the polygon mirror 251 are reflected and deflected by the reflection surfaces of the polygon mirror 251. In addition, the polygon mirror 251 rotates such that the light beams BY, BM, BC, and BK are deflected for scanning a plane perpendicular to the vertical direction.

As illustrated in FIGS. 10 and 11, the first post-scan optical system of the light beam BY includes a first fθ lens 2311, a first folding mirror 2321, a second fθ lens 2331, the second folding mirror 2341, the third folding mirror 2351, and the fourth folding mirror 2361.

The second post-scan optical system of the light beam BM includes the first fθ lens 2311, the first folding mirror 2321, the second fθ lens 2331, the second folding mirror 2341, the third folding mirror 2352, and the fourth folding mirror 2362.

That is, the first fθ lens 2311, the first folding mirror 2321, the second fθ lens 2331, and the second folding mirror 2341 are commonly included in the first post-scan optical system and the second post-scan optical system. However, the light beam BY and the light beam BM pass through different regions of the optical elements.

The third post-scan optical system of the light beam BC includes a first fθ lens 2313, a first folding mirror 2323, a second fθ lens 2333, the second folding mirror 2343, the third folding mirror 2353, and the fourth folding mirror 2363.

The fourth post-scan optical system of the light beam BK includes the first fθ lens 2313, the first folding mirror 2323, a second fθ lens 2333, the second folding mirror 2343, the third folding mirror 2354, and the fourth folding mirror 2364.

As in the first post-scan optical system and the second post-scan optical system, the first fθ lens 2313, the first folding mirror 2323, the second fθ lens 2333, and the second folding mirror 2343 are commonly included in the third post-scan optical system and the fourth post-scan optical system. However, the light beam BC and the light beam BK pass through different regions of the optical elements.

The first fθ lens 2311 and the second fθ lens 2331 are optical elements that cooperate together such that the light beams BY and BM are incident and focused on the surfaces of the photoconductive drums 161 of the image forming units 1051 and 1052. Likewise, the first fθ lens 2313 and the second fθ lens 2333 are optical elements that cooperate together such that the light beams BC and BK are incident and focused on the surfaces of the photoconductive drums 161 of the image forming units 1053 and 1054.

The first folding mirror 2321, the second folding mirror 2341, the third folding mirrors 2351 and 2352, and the fourth folding mirrors 2361 and 2362 are deflection elements for guiding the light beams BY and BM to the image forming units 1051 and 1052. Likewise, the first folding mirror 2323, the second folding mirror 2343, the third folding mirrors 2353 and 2354, and the fourth folding mirrors 2363 and 2364 are deflection elements for guiding the light beams BC and BK to the image forming units 1053 and 1054.

The first fθ lenses 2311 and 2313, the first folding mirrors 2321 and 2323, the second fθ lenses 2331 and 2333, the second folding mirrors 2341 and 2343, the third folding mirrors 2351, 2352, 2353, and 2354, and the fourth folding mirrors 2361, 2362, 2363, and 2364 are held by the housing 270.

As illustrated in FIG. 10, the light beam BY deflected by the polygon mirror 251 for scanning passes through the emission side cover glass 2641, passes through the first fθ lens 2311 to be optically affected, is reflected upward by the first folding mirror 2321, passes through the second fθ lens 2331 to be optically affected, and is reflected laterally inward by the second folding mirror 2341. Next, the light beam BY is reflected by the third folding mirror 2351 and the fourth folding mirror 2361 in order, passes through the slit glass 2011, and is directed toward the image forming unit 1051.

In addition, the light beam BK deflected by the polygon mirror 251 for scanning passes through the emission side cover glass 2643, passes through the first fθ lens 2313 to be optically affected, is reflected upward by the first folding mirror 2323, passes through the second fθ lens 2333 to be optically affected, and is reflected laterally inward by the second folding mirror 2343. Next, the light beam BK is reflected by the third folding mirror 2354 and the fourth folding mirror 2364 in order, passes through the slit glass 2014, and is directed toward the image forming unit 1054.

As illustrated in FIG. 11, the light beam BM deflected by the polygon mirror 251 for scanning passes through the emission side cover glass 2641, passes through the first fθ lens 2311, the first folding mirror 2321, and the second fθ lens 2331, and is reflected laterally inward by the second folding mirror 2341. Next, the light beam BM is reflected by the third folding mirror 2352 and the fourth folding mirror 2362 in order, passes through the slit glass 2012, and is directed toward the image forming unit 1052.

In addition, the light beam BC deflected by the polygon mirror 251 for scanning passes through the emission side cover glass 2643, passes through the first fθ lens 2313, the first folding mirror 2323, and the second fθ lens 2333, and is reflected laterally inward by the second folding mirror 2343. Next, the light beam BC is reflected by the third folding mirror 2353 and the fourth folding mirror 2363 in order, passes through the slit glass 2013, and is directed toward the image forming unit 1053.

As illustrated in FIGS. 4 and 5, the housing 270 includes: a first holding portion 271 that holds the light source stations 2111 to 2114; and a second holding portion 272 that holds the polygon mirror motor housing portion 260 (refer to FIG. 6); and a slit 273 that is formed between the first holding portion 271 and the second holding portion 272.

As described above, the housing 270 includes the plate portion that spreads across the vertical direction. The first holding portion 271 and the second holding portion 272 configure a part of the plate portion of the housing 270. The slit 273 is formed in a portion between the first holding portion 271 and the second holding portion 272 in the plate portion of the housing 270.

In a region corresponding to a gap between the light source stations 2111 to 2114 and the polygon mirror motor housing portion 260, the slit 273 mechanically or structurally separates the first holding portion 271 and the second holding portion 272 from each other. That is, the first holding portion 271 and the second holding portion 272 are discontinuous in the region corresponding to the gap between the light source stations 2111 to 2114 and the polygon mirror motor housing portion 260. Therefore, in the region corresponding to the gap between the light source stations 2111 to 2114 and the polygon mirror motor housing portion 260, the first holding portion 271 and the second holding portion 272 are discontinuous, and the effect of stress generated by deformation of the polygon mirror motor housing portion 260 is weakened.

The slit 273 is formed at a position where the optical paths of the first to fourth polygon mirror pre-incidence optical systems are exposed between the light source stations 2111 to 2114 and the polygon mirror motor housing portion 260.

In other words, a surface that crosses the housing 270 through the slit 273 crosses the optical paths of the first to fourth polygon mirror pre-incidence optical systems between the light source stations 2111 to 2114 and the polygon mirror motor housing portion 260.

That is, in projection of an optical path of the first to fourth polygon mirror pre-incidence optical system on the housing 270, the optical paths of the first to fourth polygon mirror pre-incidence optical systems intersect with the slit 273.

The first holding portion 271 and the second holding portion 272 may be integrally formed as a part of the plate portion of the housing 270 or may be formed as separate members. The slit 273 may be opened such that the optical paths of the first to fourth polygon mirror pre-incidence optical systems are exposed to the outside of the housing 270 between the first holding portion 271 and the second holding portion 272 or may be blocked such that the optical paths of the first to fourth polygon mirror pre-incidence optical systems are not exposed to the outside of the housing 270. The slit 273 may have a configuration in which the first holding portion 271 and the second holding portion 272 overlap each other in a thickness direction. The configuration of the slit 273 or the periphery thereof may be a two-dimensional configuration or a three-dimensional configuration as long as it is a configuration where the effects of the first holding portion 271 and the second holding portion 272 of opposite sides on one another during deformation are weakened.

In the housing 270 illustrated in FIGS. 4 and 5, the single slit 273 is formed between the polygon mirror motor housing portion 260 and the four light source stations 2111 to 2114. However, four slits may be formed to correspond to the four light source stations 2111 to 2114, respectively. That is, the housing 270 may include four slits corresponding to the four polygon mirror pre-incidence optical systems instead of one slit 273.

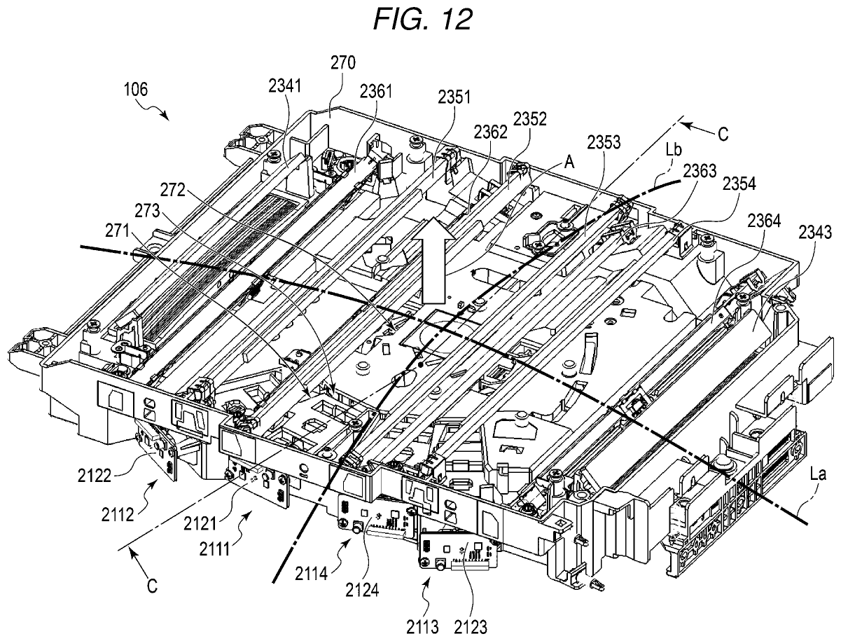

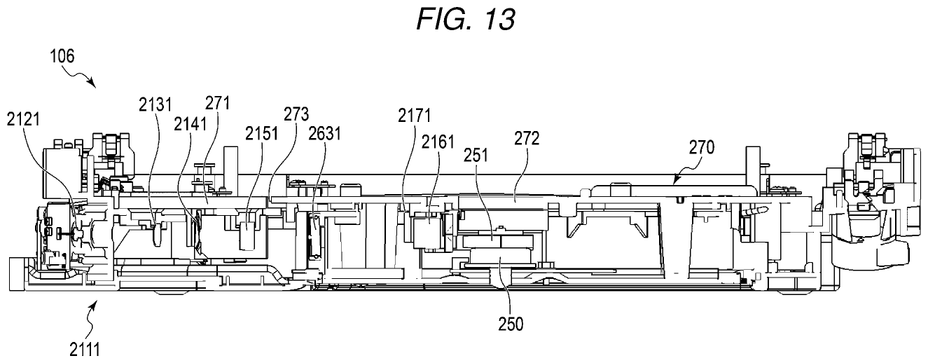

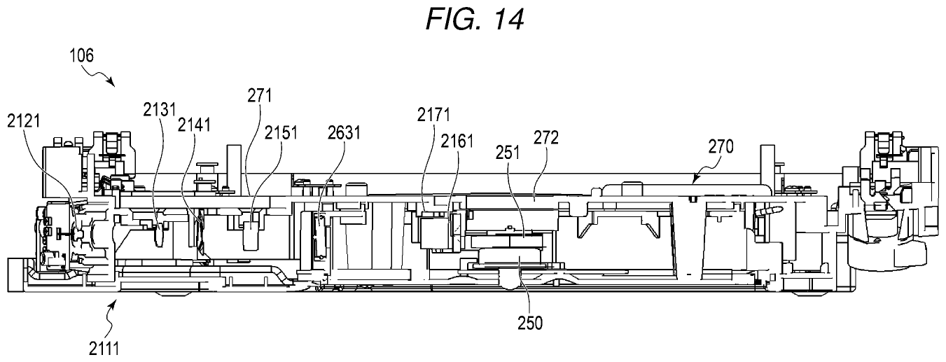

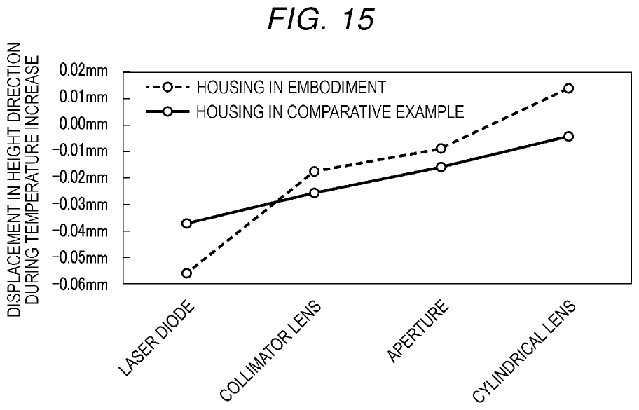

Hereinafter, the operation of the slit 273 formed in the housing 270 will be described with reference to FIGS. 12 to 15. FIG. 12 is a perspective view of the exposure device 106 corresponding to FIG. 4 and illustrating a state where the housing 270 is deformed by heat generated by the driving of the polygon mirror motor 250. FIG. 13 is a cross-sectional view taken along line C-C of the exposure device 106 illustrated in FIG. 12. FIG. 14 is a cross-sectional view illustrating the exposure device 106 according to Comparative Example where the slit is not formed in the housing 270, and is a cross-sectional view corresponding to the cross-sectional view in FIG. 13. FIG. 15 is a graph illustrating displacements of optical elements in the light source stations in the exposure devices 106 according to the embodiment and Comparative Example.

As described above, the polygon mirror motor housing portion 260 (refer to FIG. 6) that houses the polygon mirror motor 250 is held by the housing 270 and forms a closed structure. During the operation of the polygon mirror motor 250, the temperature in the surrounding atmosphere of the polygon mirror motor 250 increases due to frictional heat between the polygon mirror 251 and air and heat generated from the driver IC mounted on the substrate 252 of the polygon mirror motor 250. The temperature increase in the atmosphere causes a temperature increase in the housing 270 and the polygon plate 261 around the polygon mirror motor 250.

The housing 270 is formed of a resin, and thus has low thermal conductivity. Therefore, the temperature of the vicinity of the polygon mirror motor housing portion 260 increases. As a result, as illustrated in FIG. 12, the housing 270 is deformed by thermal expansion. Specifically, as conceptionally represented by a curve La and a curve Lb, in the housing 270, as indicated by arrow A, the second holding portion 272 that holds the polygon mirror motor housing portion 260 is deformed upward, and the end portions are deformed downward. This phenomenon is significant particularly when many images are continuously formed.

This deformation of the housing 270 inclines the first holding portion 271 that holds the light source stations 2111 to 2114. The inclination of the first holding portion 271 causes a position displacement in the vertical direction or the height direction between the optical elements of the light source stations 2111 to 2114, that is, the laser diodes 2121 to 2124, the collimator lenses 2131 to 2134, the apertures 2141 to 2144, the cylindrical lenses 2151 to 2154.

When the position displacement in the height direction between the optical elements of the light source stations 2111 to 2114 occurs, height positions and emission directions of the light beams BY, BM, BC, and BK emitted from the light source stations 2111 to 2114 are changed, and a variation in exposure position on the surfaces of the photoconductive drums 161 positioned most downstream of the first to fourth post-scan optical systems occurs. This causes deterioration in quality of an image that is finally formed on the image forming medium. In addition, mutual deviations between the exposure positions of the light beams BY, BM, BC, and BK cause color misregistration between images of the respective colors CMYK formed on the surfaces of the photoconductive drums 161.

In the exposure device 106 according to Comparative example illustrated in FIG. 14, no slit is formed in the housing 270. That is, the first holding portion 271 that holds the light source stations 2111 to 2114 and the second holding portion 272 that holds the polygon mirror motor housing portion 260 are mechanically or structurally continuous. Therefore, the deformation of the second holding portion 272 is likely to propagate to the first holding portion 271, and the first holding portion 271 is likely to be affected by the deformation of the second holding portion 272. As a result, the first holding portion 271 that holds the light source stations 2111 to 2114 is likely to be inclined.

On the other hand, in the exposure device 106 according to the embodiment illustrated in FIG. 13, the slit 273 is formed in the housing 270. That is, the first holding portion 271 that holds the light source stations 2111 to 2114 and the second holding portion 272 that holds the polygon mirror motor housing portion 260 are mechanically or structurally separated. Therefore, the deformation of the second holding portion 272 of the housing 270 is not likely to propagate to the first holding portion 271 of the housing 270, and the first holding portion 271 is not likely to be affected by the deformation of the second holding portion 272. As a result, the first holding portion 271 that holds the light source stations 2111 to 2114 is not likely to be inclined.

FIG. 15 is a graph illustrating displacements of optical elements in the light source stations in the exposure devices 106 according to the embodiment and Comparative Example under the same temperature increase condition. Specifically, displacements in the height direction of the laser diode, the collimator lens, the aperture, and the cylindrical lens are illustrated.

As clearly seen from FIG. 15, in the housing 270 according to the embodiment, mutual variations between the displacements of the laser diode, the collimator lens, the aperture, and the cylindrical lens are suppressed to be smaller than that of the housing 270 according to Comparative Example. For example, the displacement in the height direction of the laser diode is smaller than that of Comparative Example by about 30%. In addition, an overall slope of a broken line connecting the displacements of the laser diode, the collimator lens, the aperture, and the cylindrical lens is half of that of Comparative Example.

As a result, a change in the height position and the emission direction of the light beam emitted from the light source station is reduced. Thus, a variation in exposure position on the surface of the photoconductive drum is suppressed to be small. In addition, color misregistration between images of the respective colors CMYK formed on the surfaces of the photoconductive drums is suppressed to be small.

Accordingly, the embodiment provides an image forming apparatus in which a variation in exposure position on a photoreceptor that causes a temperature increase in a surrounding atmosphere of a polygon mirror motor that is being driven is small.

In the embodiment, the transfer device having the configuration in which the image formed on the photoconductive drum 161 is primarily transferred to the transfer belt 107 and the primary transfer image on the transfer belt 107 is secondarily transferred to the image forming medium P is described as an example. However, the configuration of the transfer device is not limited to this example. For example, the image formed on the photoconductive drum 161 may be directly transferred to the image forming medium P.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an exposure device configured to expose a photoreceptor to a light beam to form a latent image, the exposure device including a polygon mirror motor, a polygon mirror pre-incidence optical system, a post-scan optical system, and a housing,
the polygon mirror motor including a rotatable polygon mirror configured to deflect the light beam for scanning,
the polygon mirror pre-incidence optical system configured to cause the light beam to be incident on the polygon mirror, the polygon mirror pre-incidence optical system including a light source station configured to emit the light beam,
the post-scan optical system configured to irradiate the photoreceptor with the light beam deflected by the polygon mirror for scanning, and
the housing configured to hold the polygon mirror motor, the polygon mirror pre-incidence optical system, and the post-scan optical system, the housing comprising a resin and including a first holding portion, a second holding portion, and a slit,
the first holding portion configured to hold the light source station,
the second holding portion configured to hold the polygon mirror motor, and
the slit configured to separate the first holding portion and the second holding portion in a region corresponding to a gap between the light source station and the polygon mirror motor, the slit formed between the first holding portion and the second holding portion.

2. The image forming apparatus according to claim 1,
wherein the first holding portion and the second holding portion are discontinuous in the region corresponding to the gap between the light source station and the polygon mirror motor.

3. The image forming apparatus according to claim 1,
wherein the housing holds a polygon mirror motor housing portion that houses the polygon mirror motor, and the polygon mirror motor housing portion includes an incidence side cover glass and an emission side cover glass, the incidence side cover glass provided on an optical path of the polygon mirror pre-incidence optical system, and the emission side cover glass provided on an optical path of the post-scan optical system, and
the slit is positioned in the region corresponding to the between the light source station and the polygon mirror motor housing portion.

4. The image forming apparatus according to claim 1,
wherein a surface that passes through the slit crosses an optical path of the polygon mirror pre-incidence optical system.

5. The image forming apparatus according to claim 1,
wherein in projection of an optical path of the polygon mirror pre-incidence optical system on the housing, the optical path of the polygon mirror pre-incidence optical system intersects with the slit.

6. The image forming apparatus according to claim 1,
wherein the exposure device is configured to expose a photoreceptor to a different light beam for each color to form the latent image.

7. The image forming apparatus according to claim 1 configured so that a light beam emitted from a light source station passes through an incidence side cover glass and enters into the polygon mirror motor, and the light beam passes through a region below a polygon mirror pre-incidence mirror of the polygon mirror pre-incidence optical system and is incident on the polygon mirror.

8. The image forming apparatus according to claim 1 configured so that a light beam emitted from a light source station passes through an incidence side cover glass and enters into the housing, the light beam then reflected by two polygon mirror pre-incidence mirrors.

9. The image forming apparatus according to claim 1 configured so that a light beam emitted from a light source station passes through an incidence side cover glass, passes through a region below a polygon mirror pre-incidence mirror, and is incident on the polygon mirror.

10. The image forming apparatus according to claim 1 configured so that a light beam emitted from a light source station passes through an incidence side cover glass, reflected by two polygon mirror pre-incidence mirrors, and is incident on the polygon mirror.

11. A multifunction peripheral, comprising:
an exposure device configured to expose a photoreceptor to a light beam to form a latent image, the exposure device including a polygon mirror motor, a polygon mirror pre-incidence optical system, a post-scan optical system, and a housing,
the polygon mirror motor including a rotatable polygon mirror configured to deflect the light beam for scanning,
the polygon mirror pre-incidence optical system configured to cause the light beam to be incident on the polygon mirror, the polygon mirror pre-incidence optical system including a light source station configured to emit the light beam,
the post-scan optical system configured to irradiate the photoreceptor with the light beam deflected by the polygon mirror for scanning, and
the housing configured to hold the polygon mirror motor, the polygon mirror pre-incidence optical system, and the post-scan optical system, the housing comprising a resin and including a first holding portion, a second holding portion, and a slit,
the first holding portion configured to hold the light source station,
the second holding portion configured to hold the polygon mirror motor, and
the slit configured to separate the first holding portion and the second holding portion in a region corresponding to a gap between the light source station and the polygon mirror motor, the slit formed between the first holding portion and the second holding portion.

12. The multifunction peripheral according to claim 11,
wherein the first holding portion and the second holding portion are discontinuous in the region corresponding to the gap between the light source station and the polygon mirror motor.

13. The multifunction peripheral according to claim 11,
wherein the housing holds a polygon mirror motor housing portion that houses the polygon mirror motor, and the polygon mirror motor housing portion includes an incidence side cover glass and an emission side cover glass, the incidence side cover glass provided on an optical path of the polygon mirror pre-incidence optical system, and the emission side cover glass provided on an optical path of the post-scan optical system, and
the slit is positioned in the region corresponding to the between the light source station and the polygon mirror motor housing portion.

14. The multifunction peripheral according to claim 11,
wherein a surface that passes through the slit crosses an optical path of the polygon mirror pre-incidence optical system.

15. The multifunction peripheral according to claim 11,
wherein in projection of an optical path of the polygon mirror pre-incidence optical system on the housing, the optical path of the polygon mirror pre-incidence optical system intersects with the slit.

16. The multifunction peripheral according to claim 11,
wherein the exposure device is configured to expose a photoreceptor to a different light beam for each color to form the latent image.

17. The multifunction peripheral according to claim 11 configured so that a light beam emitted from a light source station passes through an incidence side cover glass and enters into the polygon mirror motor, and the light beam passes through a region below a polygon mirror pre-incidence mirror of the polygon mirror pre-incidence optical system and is incident on the polygon mirror.

18. The multifunction peripheral according to claim 11 configured so that a light beam emitted from a light source station passes through an incidence side cover glass and enters into the housing, the light beam then reflected by two polygon mirror pre-incidence mirrors.

19. The multifunction peripheral according to claim 11 configured so that a light beam emitted from a light source station passes through an incidence side cover glass, passes through a region below a polygon mirror pre-incidence mirror, and is incident on the polygon mirror.

20. An image forming apparatus, comprising:
an exposure device configured to expose a photoreceptor to a light beam to form a latent image, the exposure device including a polygon mirror motor, a light source station, and a housing,
the polygon mirror motor including a rotatable polygon mirror configured to deflect the light beam for scanning,
the light source station configured to emit the light beam, and
the housing configured to hold the polygon mirror motor and the light source station the housing including a first holding portion, a second holding portion, and a slit,
the first holding portion configured to hold the light source station,
the second holding portion configured to hold the polygon mirror motor, and
the slit configured to separate the first holding portion and the second holding portion in a region corresponding to a gap between the light source station and the polygon mirror motor, the slit formed between the first holding portion and the second holding portion.
